(19) United States
(12) Patent Application Publication
(10) Pub. No.: US 2008/0156711 A1
(43) Pub. Date: Jul. 3, 2008

(54) Water filter assembly and filter cartridge for use therewith

(76) Inventors: Craig R. Vitan, Louisville, KY (US); Samuel Vincent DuPlessis, Louisville, KY (US); Kyran Hoff, Louisville, KY (US); Martin Zentner, Prospect, KY (US); Rajesh Sangewar, Bhobal (IN); Derek L. Watkins, Elizabethtown, KY (US); Mark Banta, Crestwood, KY (US); Ronald Scott Tarr, Louisville, KY (US); Ratnakar Sahasrabudhe, Louisville, KY (US); Jonathan Nelson, Louisville, KY (US)

Correspondence Address: JOHN S. BEULICK (13307), ARMSTRONG TEASDALE LLP, ONE METROPOLITAN SQUARE, SUITE 2600, ST. LOUIS, MO, 63102-2740, US

(21) Appl. No.: 11/647,976

(22) Filed: Dec. 29, 2006

(51) Int. Cl. B01D 35/00

(52) U.S. Cl. 210/133; 210/136; 210/234; 210/321.72; 210/383; 210/94

(57) ABSTRACT

A dry change water filter assembly is provided. The filter assembly includes a filter head including a water by-pass valve, and a filter body configured to removably attach to the filter head. The water by-pass valve is actuated by at least one of attaching the filter body to the filter head and removing the filter body from the filter head.

### BACKGROUND OF THE INVENTION

This invention relates generally to water systems and, more particularly, to a water filter assembly and a filter cartridge for use therewith.

At least some known water filter assemblies include water filters to remove elements such as carbon, lead, mercury, bacteria, and sediment (polyspun) from water flowing through the filter assembly. Generally, the water filter has a limited life-span and is required to be changed after a determined period of time. Often, changing the water filter requires removing and replacing the filter from a wet sump. This can lead to excess water leaking from the sump and/or dripping from the filter during replacement. Currently, known methods to prevent water leakage or dripping during filter replacement requires the water system to be shut-off. Generally, shutting off the system is time consuming, depletes water availability, and/or requires an elongated start-up operation.

Further, at least some known filters do not meet the requirements to pass National Sanitation Foundation (NSF) 42 certification. Specifically, for a filter to be certified as one of NSF class one through NSF class five, the filter must achieve a minimum of an 85% reduction in sediment throughout the duration of the NSF test. At least some known filters are not capable of achieving such a reduction. Specifically, some known filters allow sediment to accumulate at the bottom of the sump. Often, this results in reduction in active surface of the filter and increases the pressure drop across the filter media. If the pressure drop exceeds the physical strength of the filter media it may collapse and allow sediment laden water to bypass. To address this problem, at least some known water filters require a different filter medium and/or at least some known water filters are derated to a lower NSF certification and/or at least some known water filters are not rated to the NSF certification. Generally, derating the filter and/or changing the filter medium results in increased manufacturing costs, decreased sale prices, and/or a limited sales market.

### BRIEF DESCRIPTION OF THE INVENTION

In one aspect, a dry change water filter assembly is provided. The filter assembly includes a filter head including a water by-pass valve, and a filter body configured to removably attach to the filter head. The water by-pass valve is actuated by at least one of attaching the filter body to the filter head and removing the filter body from the filter head.

In another aspect, a water filter cartridge is provided. The water filter cartridge includes a thin-walled pressure vessel, a filter media positioned within the thin-walled pressure vessel, and a handle coupled to the thin-walled pressure vessel. The water filter cartridge also includes a sealable water inlet configured to channel water into the filter media, and a sealable water outlet configured to channel water from the filter media.

In a further aspect, a water filter assembly is provided. The water filter assembly includes a sump, a filter cartridge positioned within the sump, and a circulation apparatus configured to circulate water to facilitate at least one of preventing sediment from settling at a bottom of the sump and providing an equal distribution of sediment across a surface of the filter cartridge.

### BRIEF DESCRIPTION OF THE DRAWINGS

FIG. 1 is a schematic view of an exemplary water treatment system.

FIG. 2 is a schematic view of an exemplary water treatment system including a plurality of filters, each filter having a by-pass valve.

FIG. 3 is a sectional view of a known water filter that may be used with the water treatment system shown in FIG. 1.

FIG. 4 is a sectional view of an exemplary water filter, in a by-pass mode, that may be used with the water treatment system shown in FIG. 2.

FIG. 5 is a sectional view of the water filter shown in FIG. 4, in a filtration mode.

FIG. 6 is a sectional view of an alternative embodiment of a water filter, in a by-pass mode, that may be used with the water treatment system shown in FIG. 2.

FIG. 7 is a sectional view of the water filter shown in FIG. 5, in a by-pass filter placement mode.

FIG. 8 is a sectional view of the water filter shown in FIG. 5, in a filtration mode.

FIG. 9 is a sectional view of an alternative embodiment of a water filter, in a by-pass mode, that may be used with the water treatment system shown in FIG. 2.

FIG. 10 is a sectional view of the water filter shown in FIG. 8, in a by-pass filter placement mode.

FIG. 11 is a sectional view of the water filter shown in FIG. 8, in a filtration mode.

FIG. 12 is a sectional view of another alternative embodiment of a water filter, in a by-pass mode, that may be used with the water treatment system shown in FIG. 2.

FIG. 13 is a sectional view of the water filter shown in FIG. 11, in a by-pass filter placement mode.

FIG. 14 is a sectional view of the water filter shown in FIG. 11, in a filtration mode.

FIG. 15 is a view of an exemplary filter cartridge suitable for use with the water treatment system shown in FIG. 2.

FIG. 16 is an exploded view of a filter head that may be used with the water treatment system shown in FIG. 2.

FIG. 17 is an exploded view of the filter cartridge shown in FIG. 14 and configured to be inserted into the filter head shown in FIG. 15.

FIG. 18 is a top view of the filter head shown in FIG. 15, in a by-pass mode.

FIG. 19 is a sectional view of the filter head shown in FIG. 15, in by-pass mode.

FIG. 20 is a top view of the filter head shown in FIG. 15, in a filtration mode.

FIG. 21 is a sectional view of the filter head shown in FIG. 15, in a filtration mode.

FIG. 22 is a sectional view an exemplary filter cartridge suitable for use with the water treatment system shown in FIG. 2.

FIG. 23 is a sectional view of another alternative water filter suitable for use with the water treatment system shown in FIG. 2.

FIG. 24 is a sectional view of yet another alternative water filter suitable for use with the water treatment system shown in FIG. 2.

FIG. 25 is a sectional view of an alternative water filter suitable for use with the water treatment system shown in FIG. 2.

FIG. 26 is a sectional view of another alternative water filter suitable for use with the water treatment system shown in FIG. 2.

FIG. 27 is a sectional view of another alternative water filter suitable for use with the water treatment system shown in FIG. 2.

### DETAILED DESCRIPTION OF THE INVENTION

The present invention provides a method and apparatus for filtering water in a water system. The system includes a water filter assembly configured to reduce an amount of sediment allowed to pass therethrough and/or configured to allow water to by-pass a filter element positioned therein. By reducing an amount of sediment allowed to pass through the filter, a higher National Sanitation Foundation (NSF) rating can be achieved without having to substitute a filter medium. Further, allowing water to by-pass the filter element allows the filter element to be changed without water leaking from the system and/or having to shut-down the system. In one embodiment, the water filter circulates sediment within water to facilitate increasing an amount of the sediment that is passed through the filter element. In an alternative embodiment, a by-pass valve is provided such that water can be directed through the filter without contacting the filter element.

The present invention is described below in reference to its application in connection with and operation of a water treatment system. However, it should be apparent to those skilled in the art and guided by the teachings herein provided that the invention is likewise applicable to any device suitable for filtering water and/or any other liquid. For example, the present invention may be used with appliances, such as, but not limited to, refrigerators, washers, and dry cleaning apparatuses. Further, the present invention could be used, universally, in home water systems.

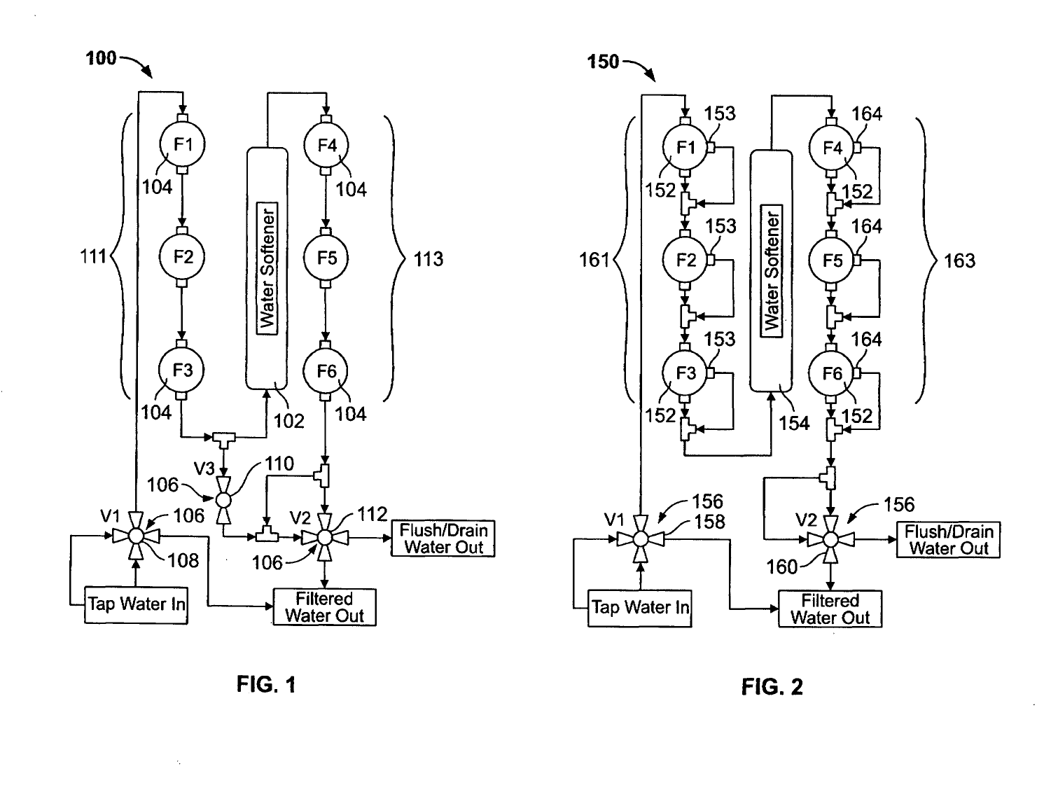

FIG. 1 is a schematic view of an exemplary water treatment system 100. As stated above, the water treatment system described herein is exemplary only, and the present invention is applicable to any device suitable for filtering water and/or any other liquid. Water treatment system 100 includes a water softener 102 coupled in flow communication with a plurality of filters 104. In one embodiment, water treatment system 100 includes six filters 104. In an alternative embodiment, water treatment system 100 includes any suitable number of filters 104. Further, each filter 104 is configured to remove impurities including, without limitation, sediment (polyspun), taste, odor, lead, mercury, bacteria, and/or viruses. As shown in FIG. 1, water treatment system 100 also includes a plurality of valves 106. Specifically, a first valve 108 is configured to by-pass system 100, a second valve 110 is configured to drain a first series 111 of filters 104 and a third valve 112 is configured to drain a second series 113 of filters 104. In an alternative embodiment, water treatment system 100 includes any suitable number of valves for draining any portion of system 100.

During operation, water flows into valve 108, wherein the water by-passes system 100 or is channeled into system 100. Water channeled into system 100 is channeled through first series 111 of filters 104. Upon channeling the water into system 100, valve 108 prevents the water from by-passing first series 111 of filters 104. After passing through first series 111 of filters 104, water is channeled to valve 110, wherein the water is drained to valve 112 or is channeled through water softener 102. Water channeled through water softener 102 is then channeled through second series 113 of filters 104. Water channeled from water softener 102 is prevented from by-passing second series 113 of filters 104 by valve 110. The water is then channeled into valve 112, wherein the water is drained from system 100 as unfiltered water or is discharged from system 100 as filtered water.

FIG. 2 is a schematic view of an alternative water treatment system 150 including a plurality of filters 152. As stated above, the water treatment system described herein is exemplary only, and the present invention is applicable to any device suitable for filtering water and/or any other liquid. Each filter 152 has a by-pass valve 153. In one embodiment, water treatment system 150 includes six filters 152. In an alternative embodiment, water treatment system 150 includes any suitable number of filters 152. Further, each filter 152 is configured to remove from water impurities including, without limitation, sediment (polyspun), taste, odor, lead, mercury, bacteria, and/or viruses. As shown in FIG. 2, water treatment system 150 also includes a water softener 154 and two valves 156 coupled in flow communication with filters 152. Specifically, a first valve 158 is configured to by-pass system 150 and a second valve 160 is configured to drain unfiltered water from system 150 or discharge filtered water from system 150. In an alternative embodiment, water treatment system 150 includes any suitable number of valves.

Referring to FIG. 2, during operation, water flows into valve 158, wherein the water by-passes system 150 or is channeled into system 150. Water channeled into system 150 is channeled to a first series 161 of filters 152. Each filter 152 includes by-pass valve 153 such that the water flows through a filter cartridge (not shown) positioned within each filter 152 or the water by-passes the filter cartridge to prevent water flow through the filter cartridge. Water flowing through first series 161 of filters 152 is then channeled through water softener 154 and into a second series 163 of filters 152. Notably, filters 152 of second series 163 also include a by-pass valve 164 such that water is channeled through a filter cartridge positioned within a corresponding filter 152 or by-passes the filter cartridge. Finally, the water is channeled to valve 160, wherein the water is drained as unfiltered water or discharged as filtered water. Notably, by preventing water flow through the filter cartridge, the filter cartridge can be replaced without water leaking from system 150 or dripping from the filter cartridge. Moreover, by-pass valve 153 and/or 164 facilitates replacing the corresponding filter cartridge without shutting down system 150.

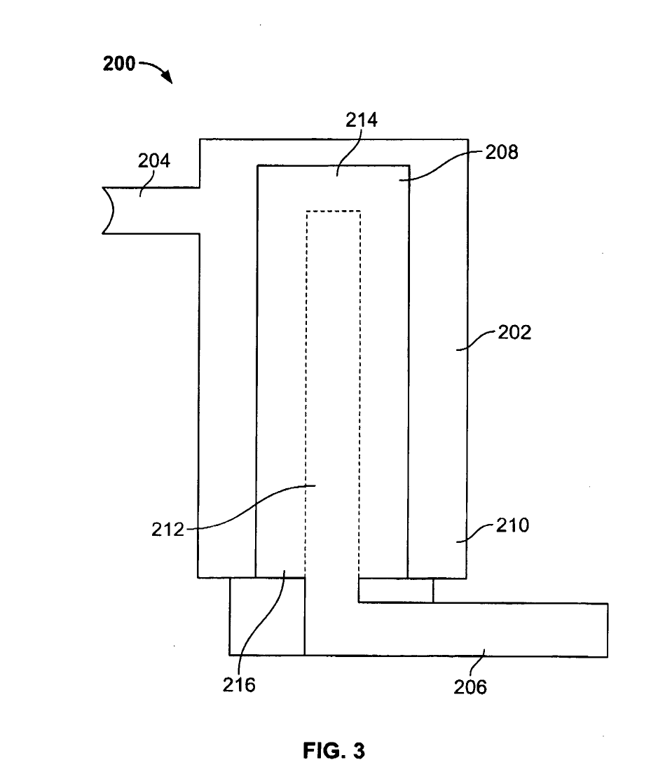

FIG. 3 is a schematic view of a water filter 200 suitable for use with water treatment system 100. Specifically, water filter 200 is an axial flow filter. Water filter 200 includes a sump 202 having an inlet 204 and an outlet 206. In one embodiment, sump 202 is generally cylindrical in shape. In an alternative embodiment, sump 202 has any suitable shape. Sump 202 includes a filter cartridge 208 positioned within a chamber 210 defined by sump 202. Filter cartridge 208 includes an axial chamber 212 extending therethrough. Specifically, axial chamber 212 extends from a top 214 of filter cartridge 208 to a bottom 216 of filter cartridge 208, where chamber 212 is coupled in flow communication with outlet 206.

During operation, water is channeled through inlet 204 into sump 202, wherein the water is circulated with respect to filter cartridge 208. In one embodiment, filter cartridge 208 facilitates removing impurities including, without limitation, sediment (polyspun), taste, odor, lead, mercury, bacteria, and/or viruses from the water as the water is channeled through filter cartridge 208 into chamber 212. Filtered water in chamber 212 is then discharged through outlet 206.

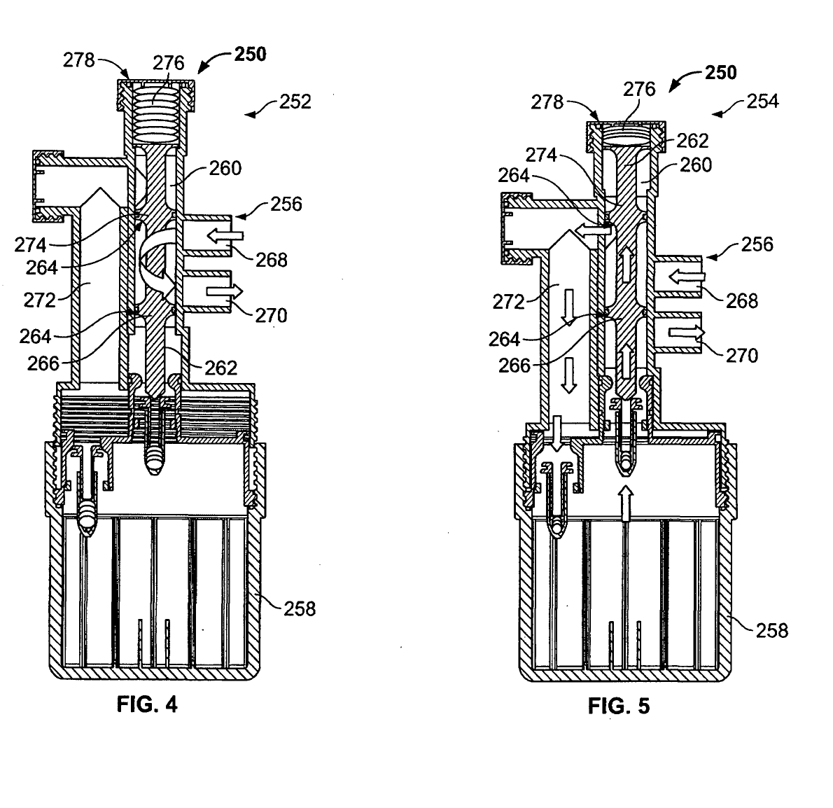

FIGS. 4 and 5 are partial sectional views of a water filter 250 suitable for use with water treatment system 150. Specifically, FIG. 4 is a view of water filter 250 in a by-pass mode 252; and FIG. 5 is a view of water filter 250 in a filtration mode 254. Water filter 250 includes a by-pass valve 256 for facilitating allowing water flowing through water filter 250 to by-pass a filter cartridge 258 defined within water filter 250. By-pass valve 256 includes a plunger chamber 260 that includes a plunger 262 having a pair of 0-rings 264 that seal chamber 260.

Plunger 262 is moveable between a first position and a second position. Specifically, FIG. 4 illustrates plunger 262 in the second position and FIG. 5 illustrates plunger 262 in the first position. With plunger 262 in the first position, as shown in FIG. 5, a first 0-ring 266 is positioned between an inlet 268 and an outlet 270 that are defined in the wall of by-pass valve 256. In this position, water channels through inlet 268 and into a by-pass valve filtration channel 272. The water flows through channel 272 and is directed into filter cartridge 258, wherein the water is filtered. Filtered water from cartridge 258 is channeled into plunger chamber 260 and is discharged through outlet 270.

With plunger 262 in the second position, as shown in FIG. 4, first O-ring 266 and a second a O-ring 274 are positioned within chamber 260 such that inlet 268 and outlet 270 are both positioned between O-rings 266 and 274. In this position, water channels through inlet 268 and is directed immediately to outlet 270. As such, the water entering water filter 250 does not channel through filter cartridge 258. Moreover, in this position filter cartridge 258 becomes sealed such that any water within cartridge 258 is not able to escape or leak from the chamber.

In one embodiment, a biasing element, such as a spring 276, is coupled to plunger 262 and an end 278 of by-pass valve 256, such that spring 276 biases plunger 262 towards the second position. When filter cartridge 258 is coupled to by-pass valve 256, spring 276 is compressed, such that plunger 262 is biased into the first position.

As such, during operation, when filter cartridge 258 is removed from by-pass valve 256, spring 276 biases plunger 262 into the second position. As such, water filter 250 is positioned in by-pass mode 252, such that filter cartridge 258 is sealed and water by-passes cartridge 258 by being channeled directly to outlet 270. By channeling the water directly to outlet 270, by-pass valve 256 facilitates changing filter cartridge 258 without water leaking from water filter 250.

When filter cartridge 258 is replaced, spring 276 is compressed by plunger 262 and plunger 262 moves into the first position. With plunger 262 in the first position, water filter 250 in positioned in filtration mode 254. As such, the by-pass valve first position facilitates filtering impurities from the water.

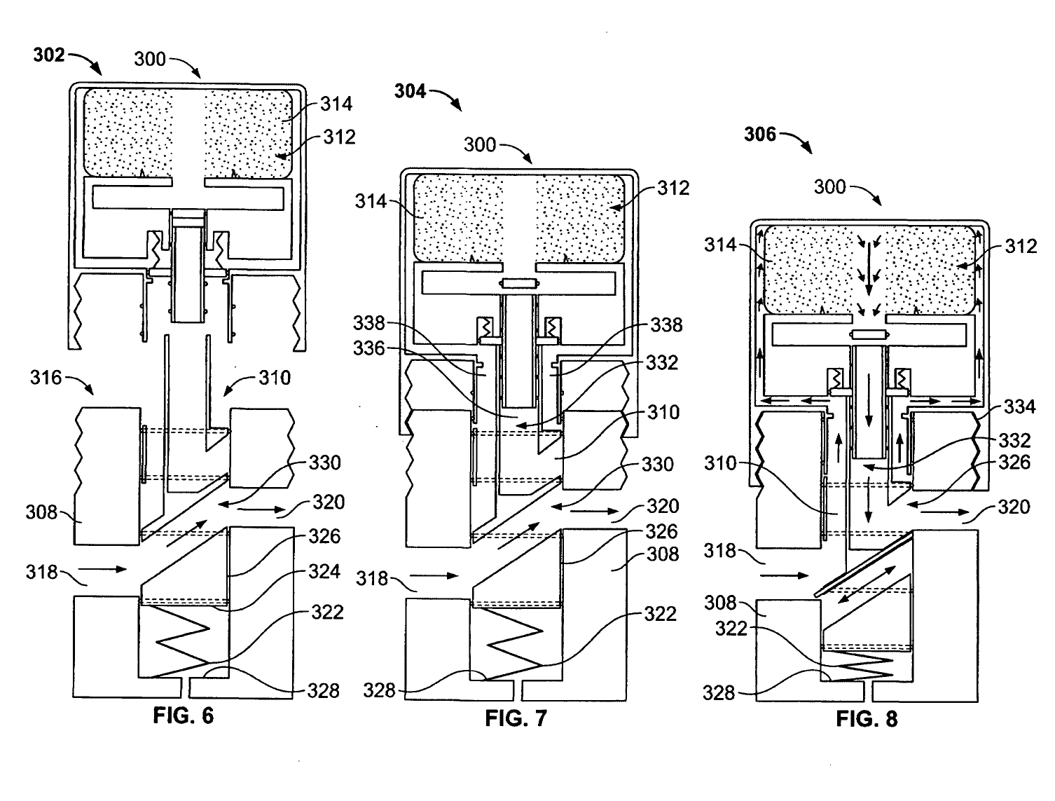

FIGS. 6-8 show sectional views of an alternative embodiment of a water filter 300 suitable for use with water treatment system 150. Specifically, FIG. 6 shows water filter 300 in a by-pass mode 302. FIG. 7 shows water filter 300 in a by-pass filter placement mode 304. FIG. 8 shows water filter 300 in a filtration mode 306. Water filter 300 includes a sump 308 having a by-pass valve 310 positioned therein. A filter cartridge 312 having a filter 314 is configured to be coupled at least partially to a top end 316 of sump 308. Sump 308 also includes an inlet 318 and an outlet 320.

In one embodiment, by-pass valve 310 includes a biasing element, such as a spring 322, coupled to a bottom end 324 of a by-pass valve body 326 and a lower surface 328 of sump 308. Body 326 defines a by-pass chamber 330 and a filter chamber 332. With filter cartridge 312 removed from sump 308, spring 322 biases or urges body 326 into by-pass mode 302, as shown in FIG. 5, wherein by-pass chamber 330 provides flow communication between inlet 318 and outlet 320. As such, water entering sump 308 through inlet 318 is channeled through by-pass chamber 330 to outlet 320. Thus, filter cartridge 312 can be removed from sump 308, while preventing or limiting water from leaking through top end 316 of sump 308.

With filter cartridge 312 initially placed on sump 308, water filter 300 remains in by-pass mode 302. Specifically, water filter 300 is in by-pass mode with filter placement mode 304. While in mode 304, water continues to channel from inlet 318 through by-pass channel 330 to outlet 320. Filter cartridge 312 is securely locked onto sump 308 via a locking mechanism 334. In one embodiment, locking mechanism 334 is threadedly coupled to filter cartridge 312. In alternative embodiments, any suitable locking mechanism couples filter cartridge 312 on sump 308.

With filter cartridge 312 secured to sump 308, filter cartridge 312 forces by-pass valve body 326 downward such that spring 322 is forced into a compressed configuration and water filter 300 is placed in filtration mode 306, as shown in FIG. 8. As such, filter chamber 332 is aligned with inlet 318 and outlet 320 such that water entering inlet 318 is channeled through filter chamber 332 into filter cartridge 312 and through filter 314. In one embodiment, the water circulates through filter 314 wherein impurities including, without limitation, sediment (polyspun), taste, odor, lead, mercury, bacteria, and/or viruses are removed from the water. After circulating through filter 314, the water is channeled back to filter chamber 332 and discharged through outlet 320.

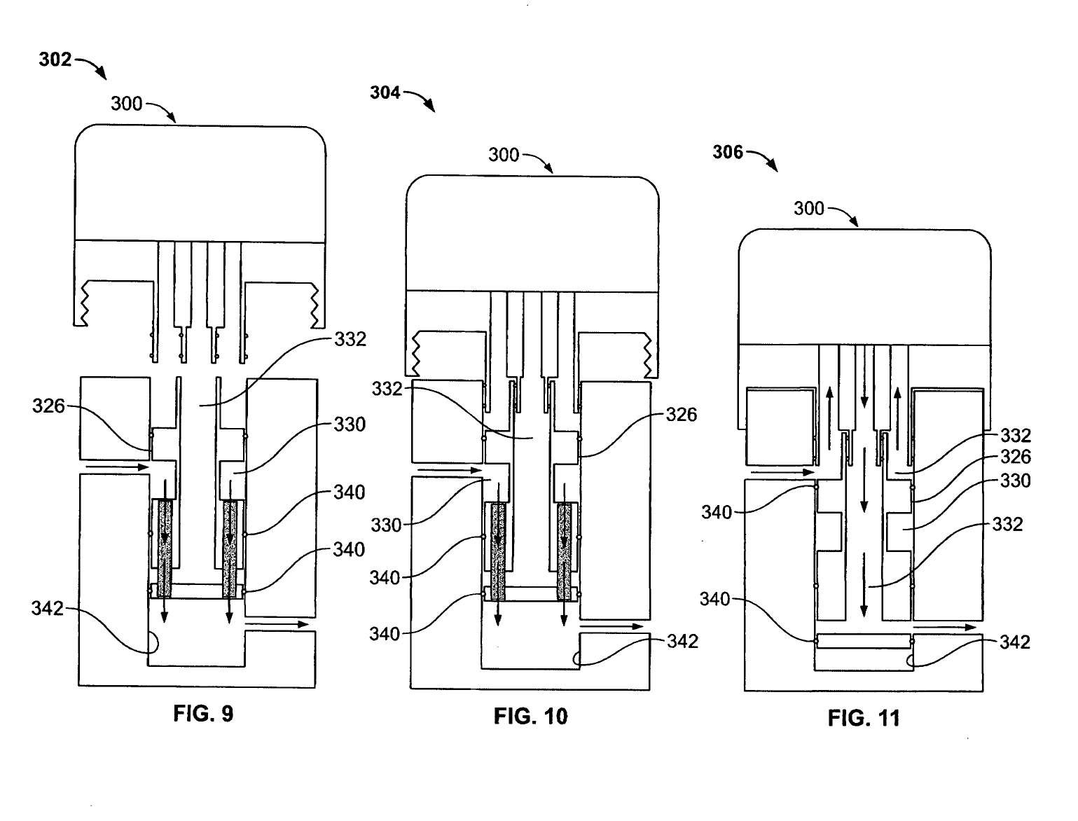

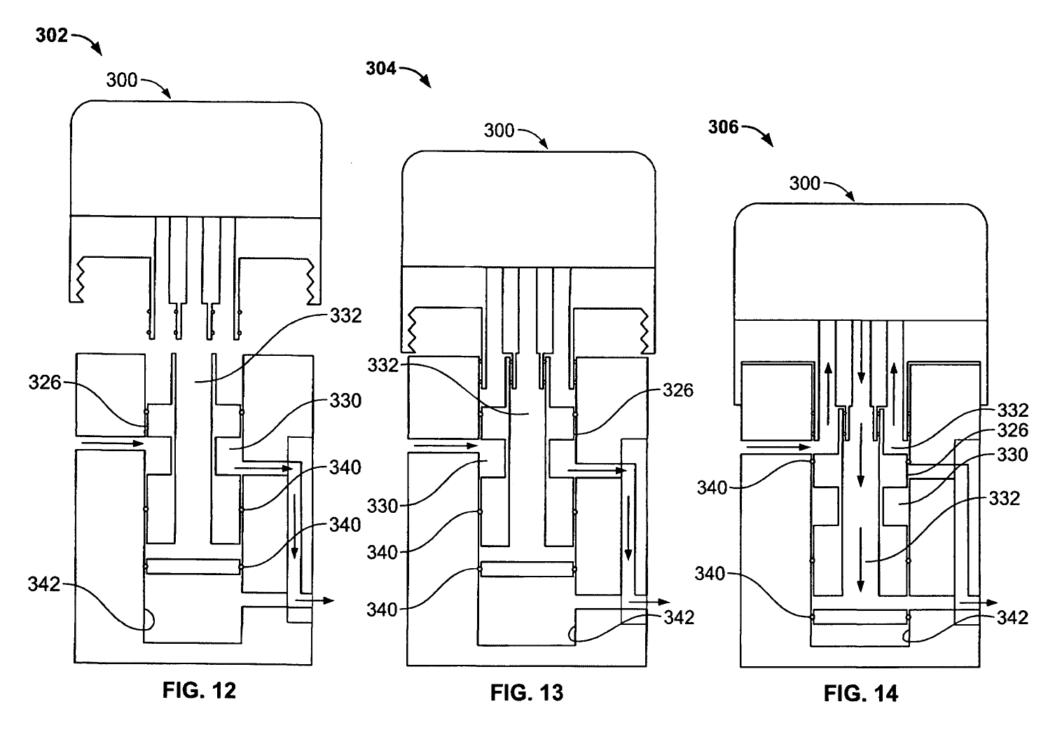

In one embodiment, body 326 defines an angled by-pass chamber 330 and filter chamber 332 defines a downward channel 336 circumscribed by an upward channel 338. Specifically, upward channel 338 channels water into filter 314, and downward channel 336 channels water from filter 314 to outlet 320. In alternative embodiments, by-pass chamber 330 and/or filter chamber 332 have different configurations. FIGS. 9-11 show an alternative embodiment of by-pass chamber 330 and filter chamber 332 suitable for use with water filter 300. Further, FIGS. 12-14 show another alternative embodiment of by-pass chamber 330 and filter chamber 332 suitable for use with water filter 300.

Moreover, FIGS. 9-11 and 12-14 show water filter 300 utilizing a friction fit rather than a biasing spring 322. Specifically, water filter 300 includes a plurality of O-rings 340 positioned about by-pass valve body 326. In one embodiment, water filter 300 includes three O-rings 340. In an alternative embodiment, water filter 300 includes any suitable number of O-rings 340. O-rings 340 provide a friction fit between body 326 and a sump inner surface 342. As such, water filter 300 is moved between by-pass mode 302 and filtration mode 306 by applying a force to body 326 that is greater than the friction force created by O-rings 340.

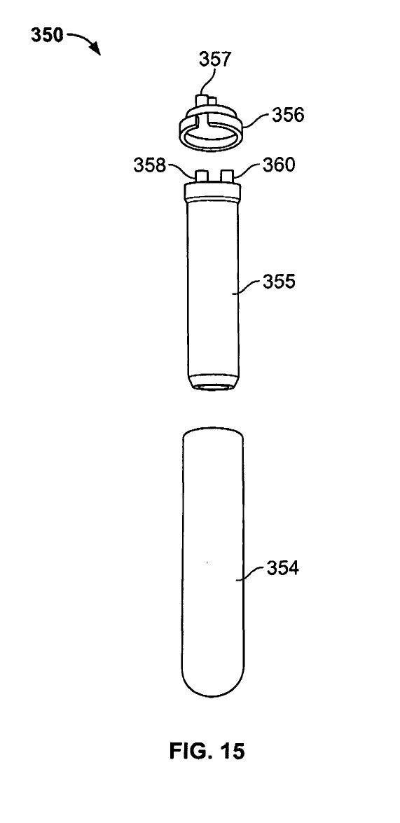

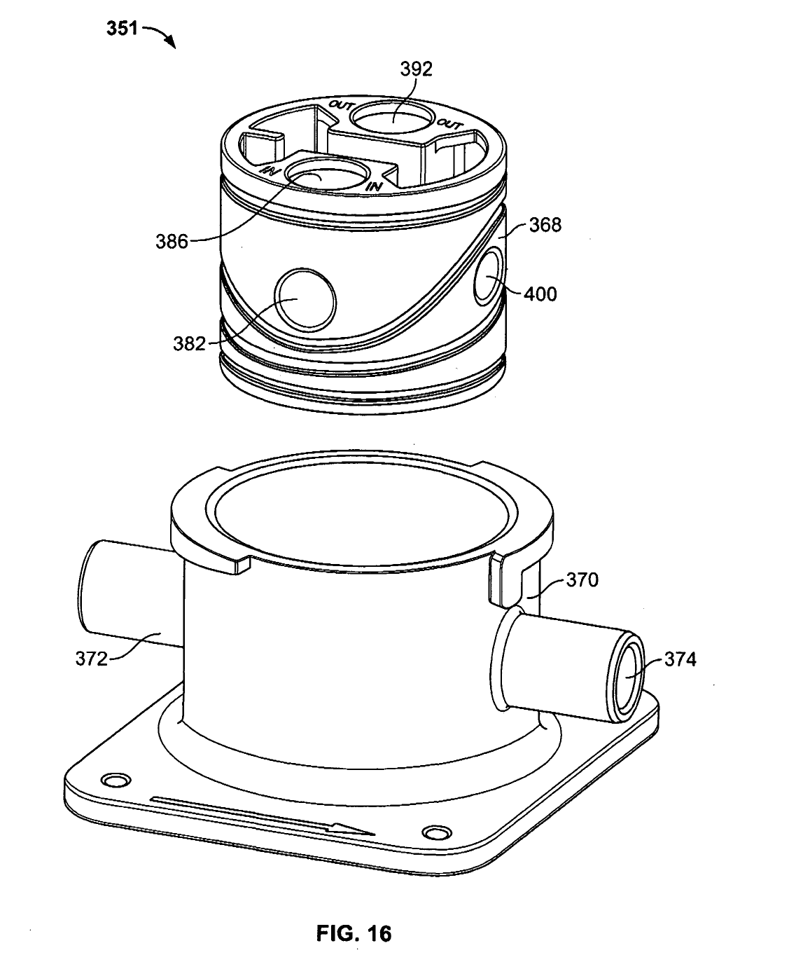

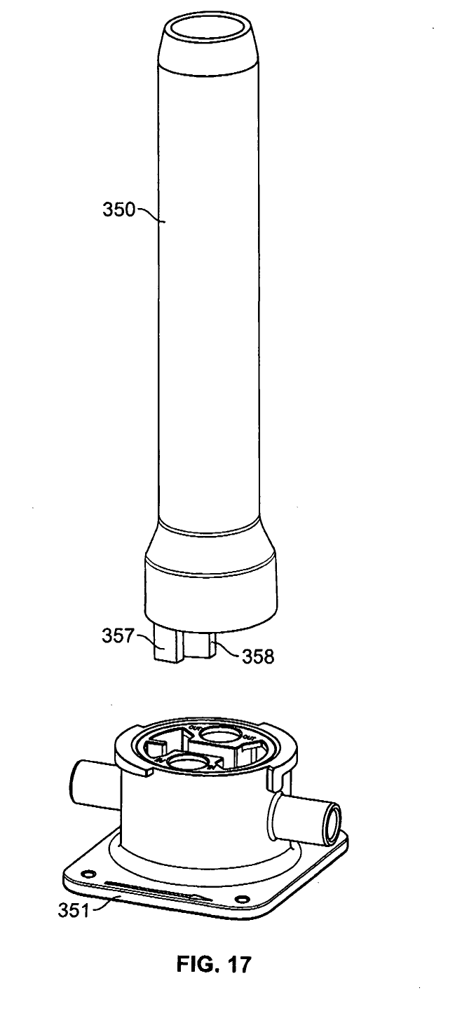

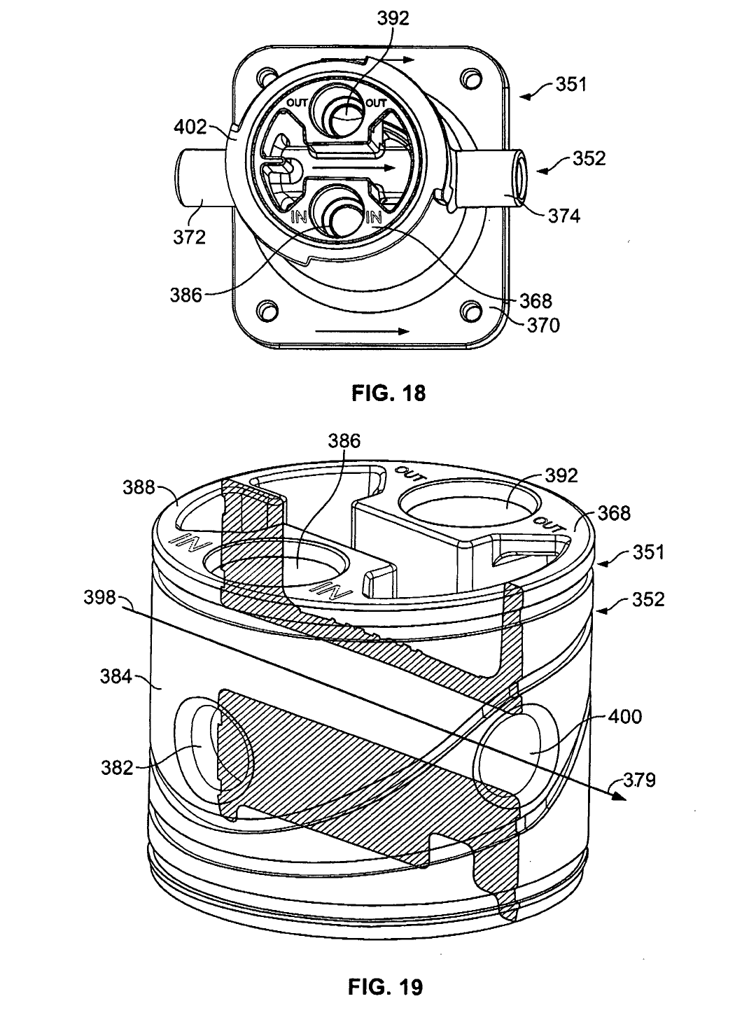

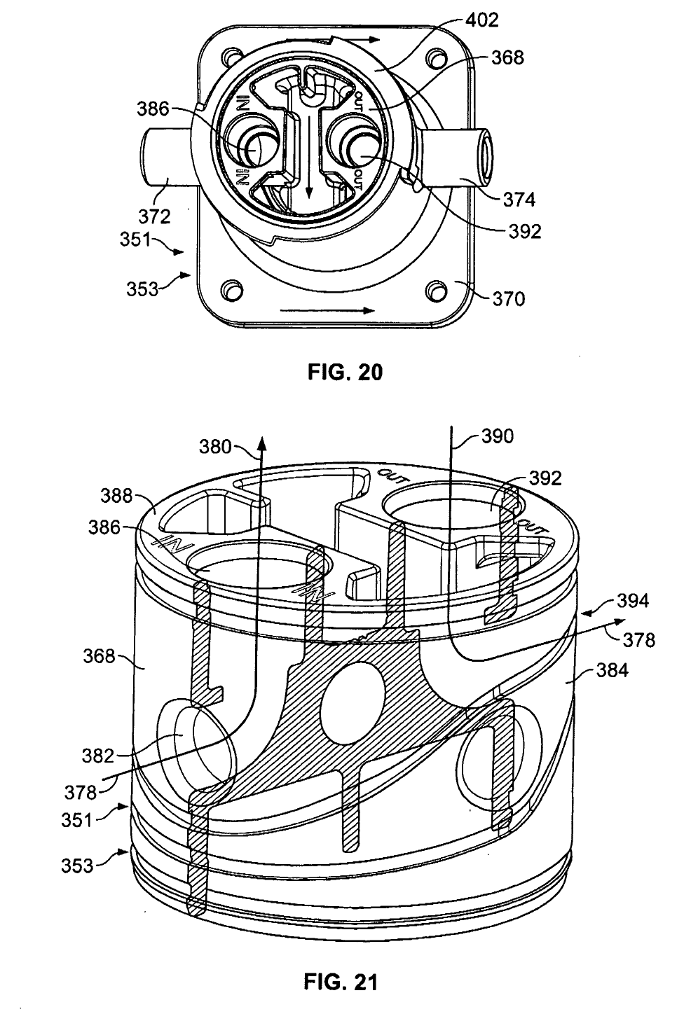

FIG. 15 shows an exemplary filter cartridge 350 suitable for use with water treatment system 150. FIG. 16 is an exploded perspective view of a filter head 351 that may be used with water treatment system 150 and is configured to receive filter cartridge 350. FIG. 17 is a perspective view of filter cartridge 350 configured to be inserted into filter head 351. FIG. 18 is a top view of filter head 351 in a by-pass mode 352. FIG. 19 is a sectional view of filter head 351 in by-pass mode 352. FIG. 20 is a top view of filter head 351 in a filtration mode 353. FIG. 21 is a sectional view of filter head 351 in filtration mode 353.

Filter cartridge 350 may be used with any by-pass valve embodiment discussed above. In one embodiment, filter cartridge 350 includes a cylindrical capsule 354 defining a suitable chamber for housing a cylindrical filter element 355, as shown in FIG. 15. In an alternative embodiment, capsule 354 and/or filter element 355 have any suitable shape to enable filter element 355 to be housed within capsule 354. In the exemplary embodiment, capsule 354 is a thin-walled pressure vessel capable of being expanded under pressure. Specifically, capsule 354 is configured to be positioned within a sump (not shown) such that, when under pressure, capsule 354 expands and makes contact with an inner wall of the sump. In an alternative embodiment, capsule 354 is made from an suitable material capable of functioning as described herein. Further, in the exemplary embodiment, capsule 354 includes a water channel therein that is configured to reduce an amount of air collected therein. Moreover, in one embodiment, capsule 354 is transparent, such that the capsule chamber is visible.

In the exemplary embodiment, filter cartridge 350 also includes a cap 356 configured to retain and enclose filter element 355 within capsule 354. Cap 356 includes a stop 357 configured to prevent rotation of filter cartridge 350, as described below. Further, filter element 355 includes a sealable inlet 358 and a sealable outlet 360 that extend through capsule 354 and couple to filter head 351. Moreover, in an alternative embodiment, filter cartridge 350 includes a handle. Filter cartridge 350 is configured to couple to filter head 351 in an upright position, an inverted position, and/or a horizontal position. In an alternative embodiment, filter cartridge 350 is configured to couple to a standard filter head and/or a custom filter head.

Filter head 351 includes a rotatable diverter 368 positioned within a filter head manifold 370 that includes an inlet 372 and an outlet 374. Filter head manifold inlet 372 is in flow communication with and configured to receive water from water treatment system 150, and filter head manifold outlet 374 is in flow communication with and configured to discharge water into water treatment system 150. Moreover, in one embodiment, filter head manifold 370 includes ducting configured to equalize pressure within the filter cartridge 350 and filter head 351 assembly. Diverter 376 includes a filter circuit 378 and a by-pass circuit 379. A first portion 380 of filter circuit 378 extends from an inlet 382 defined in a side 384 of diverter 376 to an outlet 386 defined in a top portion 388 of diverter 376. A second portion 390 of filter circuit 378 extends from an inlet 392 defined in top portion 388 to an outlet 394 defined in side 384. Filter circuit first portion outlet 386 is configured to receive and retain filter cartridge inlet 358, filter circuit second portion inlet 392 is configured to receive and retain filter cartridge outlet 360. By-pass circuit 379 extends between an inlet 398 defined in side 384 to a outlet 400 also defined in side 384.

Diverter 376 is rotatable within filter head manifold 370 between by-pass mode 352 and filtration mode 353. Specifically, diverter 376 rotates between by-pass mode 352 and filtration mode 353 until stop 357 (shown in FIG. 17) comes in contact with a ridge 402 (shown in FIG. 18 and 20) extending from filter head manifold 370. In the exemplary embodiment, diverter 376 rotates approximately ninety degrees between by-pass mode 352 and filtration mode 353. In an alternative embodiment, diverter 376 rotates within a range of approximately thirty degrees to one hundred and fifty degrees between by-pass mode 352 and filtration mode 353. In another embodiment, diverter 376 rotates within any suitable range that functions as described herein. In by-pass mode 352, by-pass circuit 379 is aligned with manifold inlet 372 and manifold outlet 374. Specifically, by-pass circuit inlet 398 is aligned with manifold inlet 372, and by-pass circuit outlet 400 is aligned with manifold outlet 374. As such, water from water treatment system 150 is channeled into manifold inlet 372, through by-pass circuit 379, through manifold outlet 374, and back to water treatment system 150.

In filtration mode 353, filter circuit 378 is aligned with manifold inlet 372 and manifold outlet 374. Specifically, filter circuit first portion inlet 382 is aligned with manifold inlet 372, and filter circuit second portion outlet 394 is aligned with manifold outlet 374. As such, manifold inlet 372 receives water from water treatment system 150 and channels the water through filter circuit first portion 380 and into capsule 354. The water channeled to capsule 354 is passed through filter element 355 such that filter element 355 facilitates removing impurities including, without limitation, sediment (polyspun), taste, odor, lead, mercury, bacteria, and/or viruses from the water. The water is then discharged from capsule 354, through filter circuit second portion 390, through manifold outlet 374, and back to water treatment system 150.

Further, diverter 376 is configured such that, with water filter cartridge 350 attached to diverter 376, diverter 376 is rotated into the first position. As such, water is enabled to channel into capsule 354. When water filter cartridge 350 is removed from diverter 376, diverter 376 is rotated into the second position such that water is enabled to by-pass filter cartridge 350. Further, when filter cartridge 350 is removed, filter cartridge inlet 358 and filter cartridge outlet 360 seal to prevent or limit excess water within filter element 355 from leaking from capsule 354.

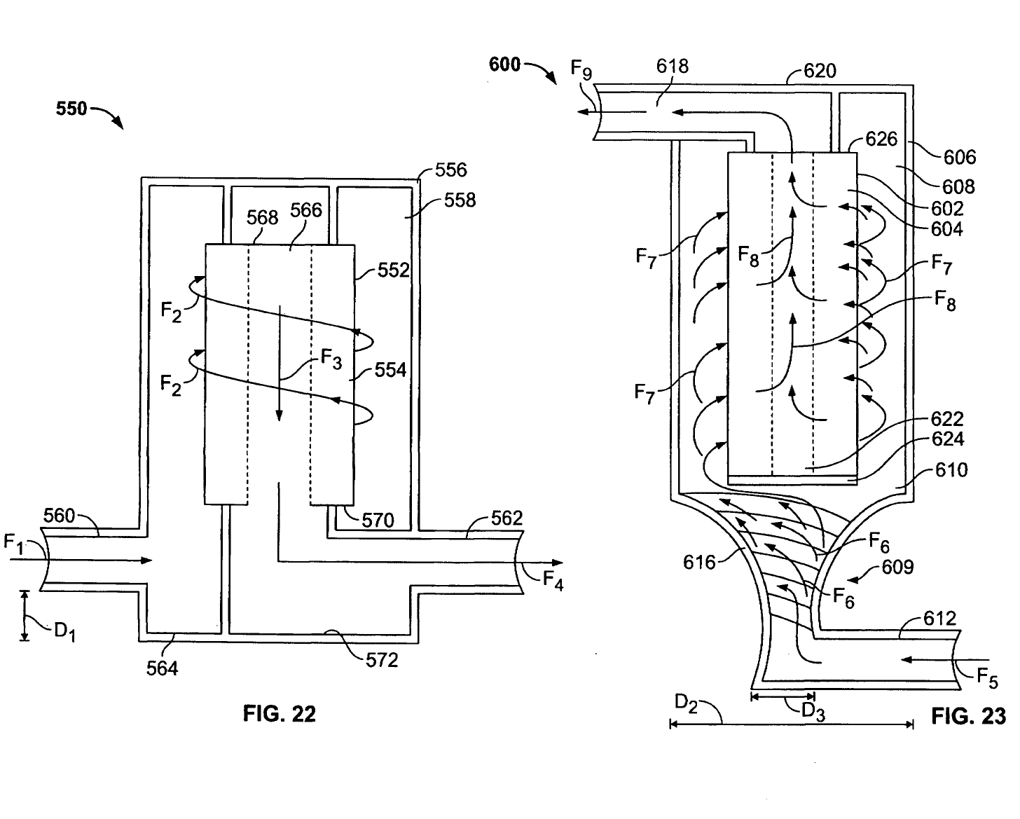

FIGS. 22-27 illustrate water filters that are configured to facilitate at least one of preventing sediment from settling at a bottom of a sump and providing an equal distribution of sediment across a surface of a filter cartridge. Specifically, if the settlement is not equally distributed along the surface of the filter cartridge, portions of the filter cartridge may become clogged with sediment. Moreover, sediment that settles at a bottom of the sump may cover and clog a portion of the filter cartridge. As such, a pressure drop caused by a reduction in an active surface area of the filter cartridge may exceed a strength of the filter cartridge causing the filter cartridge to collapse and allow sediment laden water to pass therethrough.

FIG. 22 is a sectional view of an exemplary water filter 550 suitable for use with water treatment system 150. Specifically, water filter 550 is an axial flow filter that is configured to prevent settling of sediment within a sump, such that an entire surface of a filter cartridge, positioned within the sump, is equally utilized. Specifically, water filter 550 facilitates equally distributing sediment along a surface 552 of a filter cartridge 554.

Water filter 550 may be suitable for use with at least one apparatus described above. In one embodiment, water filter 550 includes a cylindrical sump 556 defining a chamber 558 having filter cartridge 554 substantially centered at least partially therein. In an alternative embodiment, sump 556 has any suitable shape. Sump 556 includes an inlet 560 and an outlet 562. Each of inlet 560 and outlet 562 is oriented a distance D₁ from a lower surface 564 of sump 556. Filter cartridge 554 includes a chamber 566 extending axially therethrough. Specifically, chamber 566 extends from a top 568 of filter cartridge 554 through a bottom 570 of filter cartridge 554, where chamber 566 is coupled in flow communication with outlet 562.

During operation, water from water treatment system 150 is channeled into sump 556 through inlet 560, in the direction of flowpath F₁, and is circulated around filter cartridge 554, in the direction of flowpath F₂. Water circulated around filter cartridge 554 is channeled through filter cartridge 554 to chamber 566 to facilitate removing impurities therefrom. Filtered water in chamber 566 flows in the direction of flowpath F₃ and is discharged, in the direction of flowpath F₄, through outlet 562, where the filtered water returns to water treatment system 150. The circulation of the water in the direction of flowpath F₂ facilitates at least one of preventing sediment from settling at a bottom 572 of sump 556 and providing an equal distribution of sediment across surface 552 of filter cartridge 554 to facilitate increasing a life span of filter cartridge 554.

FIG. 23 is a sectional view of another exemplary water filter 600 suitable for use with water treatment system 150. Specifically, water filter 600 is an axial flow filter that is configured to prevent settling of sediment within a sump, such that an entire surface of a filter cartridge, positioned within the sump, is equally utilized. Specifically, water filter 600 facilitates equally distributing sediment along a surface 602 of a filter cartridge 604.

Water filter 600 may be suitable for use with at least one apparatus described above. Water filter 600 includes a cylindrical sump 606 defining a chamber 608 having filter cartridge 604 substantially centered at least partially therein. In an alternative embodiment, sump 606 has any suitable shape. Sump 606 includes a fluteson portion 609 that extends from a bottom 610 of sump 606 to an inlet 612. Bottom 610 has a diameter D₂ and an inlet opening 614 has a diameter D₃ that is smaller than diameter D₂. Fluteson portion 609 includes a radius portion 616 that narrows from diameter D₂ at bottom 610 to diameter D₃ at inlet opening 614. Sump 606 also includes an outlet 618 positioned at a top 620 of sump 606. Filter cartridge 604 includes a chamber 622 extending axially therethrough. Specifically, chamber 622 extends from a bottom 624 of filter cartridge 604 through a top 626 of filter cartridge 604, where chamber 622 is coupled in flow communication with outlet 618.

During operation, water from water treatment system 150 is channeled through inlet 612,in the direction of flowpath F₅, to inlet opening 614. The water flows through fluteson portion 609 and is circulated, in the direction of flowpath F₆, such that the water flow enters sump 606 and is circulated around filter cartridge 604 in the direction of flowpath F₇. Water circulated around filter cartridge 604 is channeled through filter cartridge 604 to chamber 622 to facilitate removing impurities therefrom. Filtered water in chamber 622 flows in the direction of flowpath F₈ and is discharged, in the direction of flowpath F₉, through outlet 618, where the filtered water returns to water treatment system 150. The circulation of the water in the direction of flowpath F₆ facilitates at least one of preventing sediment from settling at bottom 610 of sump 606 and providing an equal distribution of sediment across surface 602 of filter cartridge 604 to facilitate increasing a life span of filter cartridge 604.

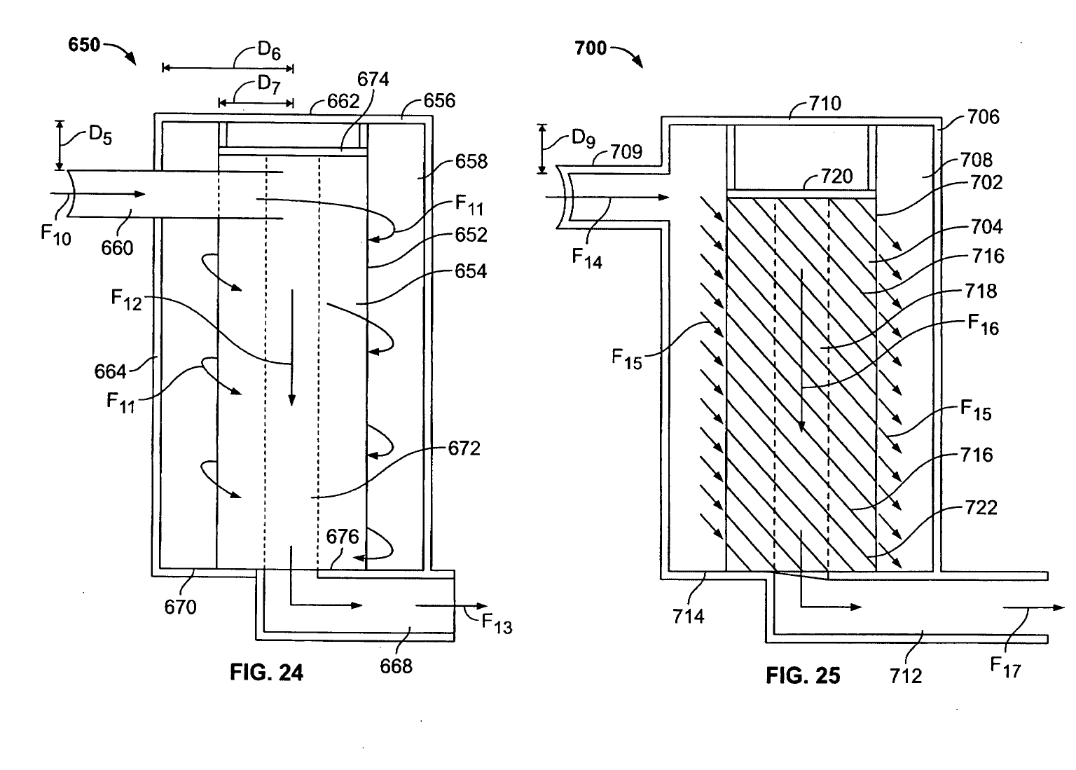

FIG. 24 is a sectional view of yet another exemplary water filter 650 suitable for use with water treatment system 150. Specifically, water filter 650 is an axial flow filter that is configured to prevent settling of sediment within a sump, such that an entire surface of a filter cartridge, positioned within the sump, is equally utilized. Specifically,water filter 650 facilitates equally distributing sediment along a surface 652 of a filter cartridge 654.

Water filter 650 may be suitable for use with at least one apparatus described above. Water filter 650 includes a cylindrical sump 656 defining a chamber 658 having filter cartridge 654 substantially centered at least partially therein. In an alternative embodiment, sump 656 has any other suitable shape. Sump 656 includes an inlet 660 oriented a distance D₅ from a sump upper surface 662 and extending a distance D₆ from a sump sidewall 664 such that inlet 660 extends tangentially to filter cartridge 654 a distance D₇. Sump 656 also includes an outlet 668 positioned at a bottom 670 of sump 656. Filter cartridge 654 includes a chamber 672 extending axially therethrough. Specifically, chamber 672 extends from a top 674 of filter cartridge 654 through a bottom 676 of filter cartridge 654, where chamber 672 is coupled in flow communication with outlet 668.

During operation, water is channeled from water treatment system 150 through inlet 660, in the direction of flowpath F₁₀, and into sump 656. Specifically, the water is channeled tangentially to filter cartridge 654 and circulates around filter cartridge 654, in the direction of flowpath F₁₁. Water circulated around filter cartridge 654 is channeled through filter cartridge 654 to chamber 672 to facilitate removing impurities therefrom. Filtered water in chamber 672 flows in the direction of flowpath F₁₂ and is discharged, in the direction of flowpath F₁₃, through outlet 668, where the filtered water returns to water treatment system 150. The circulation of the water in the direction of flowpath F₁₁ facilitates at least one of preventing sediment from settling at bottom 670 of sump 656 and providing an equal distribution of sediment across surface 652 of filter cartridge 654 to facilitate increasing a life span of filter cartridge 654.

FIG. 25 is a sectional view of an alternative water filter 700 suitable for use with water treatment system 150. Specifically, water filter 700 is an axial flow filter and is configured to mix sediment to prevent settling within a sump, such that an entire surface of a filter cartridge, positioned within the sump, is equally utilized. Specifically, water filter 700 facilitates equally distributing sediment along a surface 702 of a filter cartridge 704.

Water filter 700 may be suitable for use with at least one apparatus described above. Water filter 700 includes a cylindrical sump 706 defining a chamber 708 having filter cartridge 704 substantially centered at least partially therein. In an alternative embodiment, sump 706 has any suitable shape. Sump 706 includes an inlet 709 oriented a distance D₉ from a sump upper surface 710. Sump 706 also includes an outlet 712 positioned at a bottom 714 of sump 706. Filter cartridge 704 includes a plurality of paths 716 extending along surface 702. Filter cartridge 704 also includes a chamber 718 extending axially therethrough. Specifically, chamber 718 extends from a top 720 of filter cartridge 704 through a bottom 722 of filter cartridge 704, where chamber 718 is coupled in flow communication with outlet 712.

During operation, water is channeled from water treatment system 150 through inlet 709, in the direction of flowpath F₁₄, and into sump 706. The water is channeled along helical paths 716 such that the water circulates around filter cartridge 704, in the direction of flowpath F₁₅. Water circulated around filter cartridge 704 is channeled through filter cartridge 704 to chamber 718 to facilitate removing impurities therefrom. Filtered water in chamber 718 flows in the direction of flowpath F₁₆ and is discharged, in the direction of flowpath F₁₇, through outlet 712, where the filtered water returns to water treatment system 150. The circulation of the water in the direction of flowpath F₁₄ facilitates at least one of preventing sediment from settling at bottom 714 of sump 706 and providing an equal distribution of sediment across surface 702 of filter cartridge 704 to facilitate increasing a life span of filter cartridge 704.

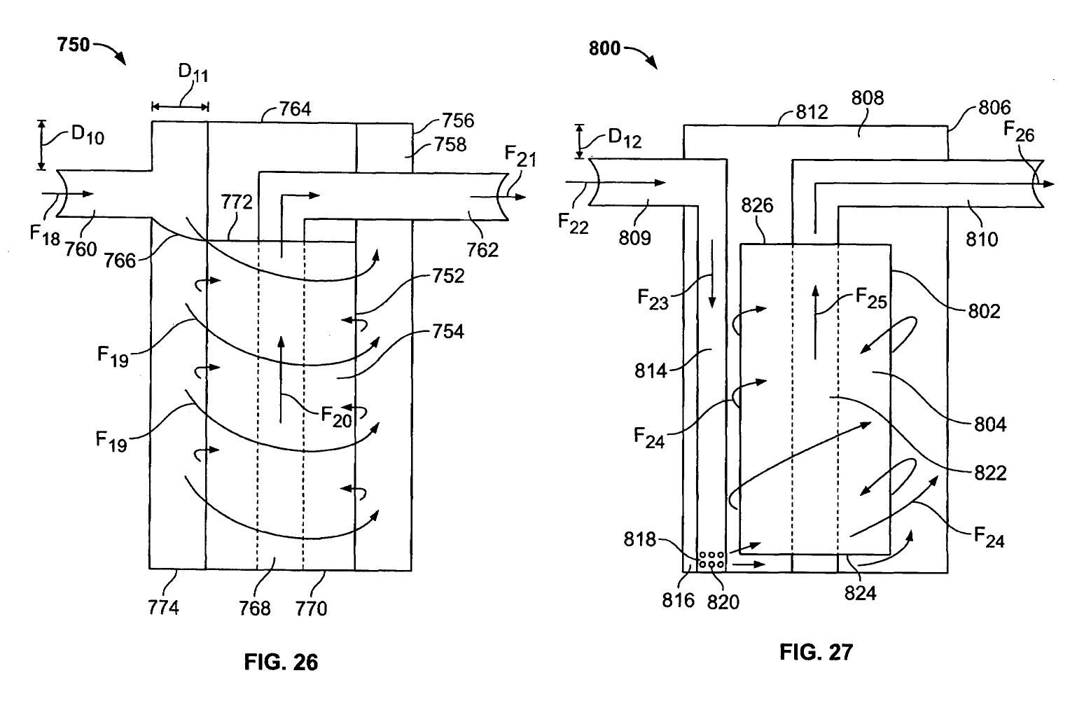

FIG. 26 is a sectional view of another alternative water filter 750 suitable for use with water treatment system 150. Specifically, water filter 750 is an axial flow filter that is configured to mix sediment to prevent settling within a sump, such that an entire surface of a filter cartridge, positioned within the sump, is equally utilized. Specifically, water filter 750 facilitates equally distributing sediment along a surface 752 of a filter cartridge 754.

Water filter 750 may be suitable for use with at least one apparatus described above. Water filter 750 includes a cylindrical sump 756 defining a chamber 758 having filter cartridge 754 substantially centered at least partially therein. In an alternative embodiment, sump 756 has any suitable shape. Sump 756 includes an inlet 760 and an outlet 762. Each of inlet 760 and outlet 762 is oriented a distance D₁₀ from a sump upper surface 764. Inlet 760 includes an inducer 766 extending a distance D₁₁, into sump 756. Filter cartridge 754 includes a chamber 768 extending axially therethrough. Specifically, chamber 768 extends from a bottom 770 of filter cartridge 754 through a top 772 of filter cartridge 754, where chamber 768 is coupled in flow communication with outlet 762.

During operation, water is channeled from water treatment system 150 through inlet 760, in the direction of flowpath F₁₈, and into sump 756. The water is directed by inducer 764 to circulate around filter cartridge 754, in the direction of flowpath F₁₉. Water circulated around filter cartridge 754 is channeled through filter cartridge 754 to chamber 768 to facilitate removing impurities therefrom. Filtered water in chamber 788 flows in the direction of flowpath F₂₀ and is discharged, in the direction of flowpath F₂₁, through outlet 762, where the filtered water returns to water treatment system 150. The circulation of the water in the direction of flowpath F₁₉ facilitates at least one of preventing sediment from settling at a bottom 774 of sump 756 and providing an equal distribution of sediment across surface 752 of filter cartridge 754 to facilitate increasing a life span of filter cartridge 754.

FIG. 27 is a sectional view of another water filter 800 suitable for use with water treatment system 150. Specifically, water filter 800 is an axial flow filter that is configured to mix sediment to prevent settling within a sump, such that an entire surface of a filter cartridge, positioned within the sump, is equally utilized. Specifically, water filter 800 facilitates equally distributing sediment along a surface 802 of a filter cartridge 804.

Water filter 800 may be suitable for use with at least some of the apparatuses described hereinabove. Water filter 800 includes a cylindrical sump 806 defining a chamber 808 having filter cartridge 804 substantially centered at least partially therein. In an alternative embodiment, sump 806 has any suitable shape. Sump 806 includes an inlet 809 and an outlet 810, each oriented at a distance D₁₂ from a sump upper surface 812. Inlet 809 includes a tube 814 coupled thereto and extending to a sump lower surface 816. In the exemplary embodiment, an end 818 of tube 814 includes a plurality of apertures 820. In an alternative embodiment, end 818 includes any suitable outlet(s). Filter cartridge 804 includes a chamber 822 extending axially therethrough. Specifically, chamber 822 extends from a bottom 824 of filter cartridge 804 through a top 826 of filter cartridge 804, where chamber 822 is coupled in flow communication with outlet 810.

During operation, water is channeled from water treatment system 150 through inlet 809, in the direction of flowpath F₂₂, and through tube 814, in the direction of flowpath F₂₃. The water is discharged through apertures 820 such that water circulates around filter cartridge 804, in the direction of flowpath F₂₄. Water circulated around filter cartridge 804 is channeled through filter cartridge 804 to chamber 822 to facilitate removing impurities therefrom. Filtered water in chamber 822 flows in the direction of flowpath F₂₅ and is discharged, in the direction of flowpath F₂₆, through outlet 810, where the filtered water returns to water treatment system 150. The circulation of the water in the direction of flowpath F₂₄ facilitates at least one of preventing sediment from settling on lower surface 816 of sump 806 and providing an equal distribution of sediment across surface 802 of filter cartridge 804 to facilitate increasing a life span of filter cartridge 804.

In one embodiment, a method for assembling a water treatment system is provided. The method includes providing a tap configured to receive water, coupling a drain in flow communication with the tap, configuring the drain to discharge water, and coupling a plurality of water filters in flow communication between the tap and the drain. In a particular embodiment, coupling at least one water filter includes coupling an inlet of a sump to the tap and coupling an outlet of the sump to the drain. The inlet is configured to receive water from the tap and the outlet is configured to discharge water to the drain. Coupling at least one water filter also includes positioning a filter cartridge at least partially within the sump and coupling a by-pass valve in flow communication between the inlet and the outlet. The by-pass valve is moveable between a first position and a second position. In the first position, the by-pass valve channels water through the filter between the inlet and the outlet. In the second position, the by-pass valve channels water from the inlet to the outlet by-passing the filter cartridge.

The above-described system and method for filtering water and/or replacing a water filter allows water systems to achieve increased sediment removal, while being easily maintained. More specifically, the system facilitates mixing sediment within the filter to increase an amount of sediment channeled through a filter element. Further, the system facilitates replacing the filter element without water leaking from the system. As a result, a more efficient and more easily maintainable water system is provided.

Exemplary embodiments of apparatus and methods for facilitating enhancing sediment removal in a water filter are described above in detail. Further, the apparatus and methods facilitate replacing the water filter when necessary. The apparatus and methods are not limited to the specific embodiments described herein, but rather, components of the apparatus and/or steps of the methods may be utilized independently and separately from other components and/or steps described herein. Further, the described apparatus components and/or method steps can also be defined in, or used in combination with, other apparatus and/or methods, and are not limited to practice with only the apparatus and methods as described herein.

As used herein, an element or step recited in the singular and proceeded with the word “a” or “an” should be understood as not excluding plural said elements or steps, unless such exclusion is explicitly recited. Further, references to “one embodiment” of the present invention are not intended to be interpreted as excluding the existence of additional embodiments that also incorporate the recited features.

While the invention has been described in terms of various specific embodiments, those skilled in the art will recognize that the invention can be practiced with modification within the spirit and scope of the claims.

What is claimed is:

1. A dry change water filter assembly comprising:
a filter head comprising a water by-pass valve; and
a filter body configured to removably attach to said filter head, said water by-pass valve actuated by at least one of attaching said filter body to said filter head and removing said filter body from said filter head.

2. A dry change water filter assembly in accordance with claim 1 wherein said water by-pass valve comprises a piston that is moveable between a first position and a second position, said first position enables water to channel into said filter body when said filter body is attached to said filter head, and said second position enables water to channel through said filter head.

3. A dry change water filter assembly in accordance with claim 2 wherein said piston moves into said first position when said filter head is attached to said filter body, and said piston moves into said second position when said filter head is removed from said filter body.

4. A dry change water filter assembly in accordance with claim 2 wherein said filter head further comprises ducting to equalize pressure along sides of said piston when said piston is in said first position, said piston is in said second position, and said piston is in transition between said first position and said second position.

5. A dry change water filter assembly in accordance with claim 1 wherein said filter body is sealed when removed from said filter head to facilitate preventing water within said filter body from escaping.

6. A dry change water filter assembly in accordance with claim 1 wherein said water by-pass valve comprises a plurality of pistons that are each moveable between a first position and a second position.

7. A dry change water filter assembly in accordance with claim 1 wherein said by-pass valve is configured to rotate within a range of about 30° to about 150° between a first position and a second position, said by-pass valve rotated to said first position when said filter body is attached to said filter head to enable water to channel into said filter body, and said by-pass valve rotated to said second position when said filter body is removed from said filter head to enable water to channel through said filter head.

8. A dry change water filter assembly in accordance with claim 1 wherein said filter body is configured to attach to said filter head in at least one of an upright position, an inverted position, and a horizontal position.

9. A dry change water filter assembly in accordance with claim 1 wherein said filter body comprises:
a thin-walled pressure vessel;
a filter media positioned within said thin-walled pressure vessel;
a sealable water inlet configured to channel water toward said filter media; and
a sealable water outlet configured to channel water from said filter media.

10. A dry change water filter assembly in accordance with claim 1 further comprising a circulation apparatus configured to circulate water to facilitate reducing an amount of sediment that settles on said filter cartridge.

11. A filter cartridge comprising:
a thin-walled pressure vessel;
a filter media positioned within said thin-walled pressure vessel;
a sealable water inlet configured to channel water into said filter media; and
a sealable water outlet configured to channel water from said filter media.

12. A filter cartridge in accordance with claim 11 wherein said filter cartridge is configured for use with at least one of a standard filter head and a custom filter head.

13. A filter cartridge in accordance with claim 11 configured to be positioned within a sump.

14. A filter cartridge in accordance with claim 13 wherein said thin-walled pressure vessel is configured to expand to contact a sidewall of the sump when pressurized.

15. A filter cartridge in accordance with claim 11 wherein said sealable inlet and said sealable outlet are configured to seal said thin-walled pressure vessel when unpressurized.

16. A filter cartridge in accordance with claim 11 wherein said thin-walled pressure vessel comprises a water channel configured to facilitate reducing an amount of air collected within said filter cartridge.

17. A filter cartridge in accordance with claim 11 wherein said thin-walled pressure vessel is transparent.

18. A filter cartridge in accordance with claim 11 further comprising a handle coupled to said thin-walled pressure vessel.

19. A water filter assembly comprising:
a sump;
a filter cartridge positioned within said sump; and
a circulation apparatus configured to circulate water to facilitate at least one of preventing sediment from settling at a bottom of said sump and providing an equal distribution of sediment across a surface of said filter cartridge.

20. A water filter assembly in accordance with claim 19 wherein said circulation apparatus comprises an inducer coupled to said sump and configured to channel water around said filter cartridge.

21. A water filter assembly in accordance with claim 19 wherein said circulation apparatus comprises a tube configured to channel water to a bottom of said sump to facilitate agitating the sediment.

22. A water filter assembly in accordance with claim 19 wherein said circulation apparatus comprises at least one insert positioned on said surface of said filter cartridge, said insert configured to circulate water around said filter cartridge.

23. A water filter assembly in accordance with claim 19 wherein said circulation apparatus comprises an inlet port coupled to said sump and extending tangentially with respect to said filter cartridge to facilitate agitating the water.

24. A water filter assembly in accordance with claim 19 wherein said circulation apparatus comprises a fluted member coupled to said bottom of said sump and configured to channel water circumferentially about said filter cartridge.
